(19) United States
(12) Patent Application Publication
(10) Pub. No.: US 2022/0215765 A1
(43) Pub. Date: Jul. 7, 2022

(54) CLOUD-BASED AIRCRAFT EMERGENCY NOTIFIER (CAEN)

(71) Applicant: The Boeing Company, Chicago, IL (US)

(72) Inventors: Bishwadeep Gupta, Bangalore (IN); Kiran Gopala Krishna, Bangalore (IN)

(21) Appl. No.: 17/455,389

(22) Filed: Nov. 17, 2021

(30) Foreign Application Priority Data
Jan. 7, 2021 (IN) 202111000792

(51) Int. Cl. G08G 5/00

(52) U.S. Cl. CPC G08G 5/0039; G08G 5/006; G08G 5/0013

(57) ABSTRACT

A cloud-based aircraft emergency notifier (CAEN) is disclosed herein. In one or more embodiments, a system for emergency notification comprises an aircraft configured to transmit data signals. The system further comprises a notifier configured to: receive the data signals transmitted from the aircraft; determine whether the data signals comprise an emergency alert; monitor for any subsequent data signals transmitted from the aircraft for a first period of time, when the notifier determines that the data signals comprise the emergency alert or when the notifier determines that the aircraft has stopped transmitting any signals; and transmit first emergency notification messages to other aircraft located within a same airspace as the aircraft, to an air traffic control (ATC) for the airspace of the aircraft, and/or to an airline operations center (AOC) associated with an airlines of the aircraft, after the first period of time has elapsed.

### CROSS-REFERENCE TO RELATED APPLICATIONS

This application claims the benefit of the filing date and right of priority under 35 U.S.C. § 119(a)-(d) of Indian Patent Application No. 202111000792, filed in the Indian Patent Office on Jan. 7, 2021, the disclosure of which is incorporated herein by reference in its entirety.

### FIELD

The present disclosure relates to an emergency notifier. In particular, the present disclosure relates to a Cloud-based Aircraft Emergency Notifier (CAEN).

### BACKGROUND

Historically, aircraft emergencies have occurred including the loss of an aircraft or loss of communication with an aircraft. In such events with distressed aircraft, it may take a significant amount of time for an air navigation service provider (ANSP), air traffic control (ATC), and/or regulatory authority to make informed decisions as to how to restrict routes to, or airspaces over, in the region of the emergency.

Further, “hot zones” may arise due to natural disasters (e.g., sudden severe weather events, such as a volcano erupting volcanic ash) or via man-made events (such as human conflicts, which create militant and/or war zones). During flight, aircraft typically follow pre-defined routes (e.g., comprising low and high altitude airways). If a potential hot zone appears suddenly en route of the flight and there is a loss of the aircraft, the air traffic approaching the hot zone will have no awareness of either the loss of aircraft or the emergence of the hot zone. This may increase risks for the aircraft flying near such a region.

The existing solutions employed for aircraft emergency events may be time consuming and slow. Currently, if there is a loss of communication with a specific aircraft within a region, the ATC communicates with nearby air traffic within the region. The ATC also monitors surveillance radar imagery, if available. However, these existing solutions are very time consuming and slow because they rely heavily on human in-the-loop monitoring and they may lack real-time alert or push notification systems for the nearby aircraft traffic within the airspace.

As such, existing solutions appear to have two main disadvantages. A first disadvantage is that the aircraft traffic flying within an airspace comprising an emergency event or incident may not receive real-time notifications and/or alerts of accidents and/or incidents occurring within their airspace. Thus, the operators of these aircraft lack situational awareness when they are instructed by the ATC to either offset or change their current flight path. A second disadvantage may be the making of a decision (e.g., by the ATC) to close or restrict an airspace due to an emergency event or incident is usually slow because there are limited information channels open to the decision-making authorities (e.g., the ATC).

In light of the foregoing, there is a need for an improved design for an automatic aircraft emergency notification system and method.

### SUMMARY

The present disclosure relates to a method, system, and apparatus a cloud-based aircraft emergency notifier (CAEN). In one or more embodiments, a method for emergency notification comprises receiving, by a notifier, data signals transmitted from an aircraft. The method further comprises determining, by the notifier, whether the data signals comprise an emergency alert. Also, the method comprises monitoring, by the notifier, for any subsequent data signals transmitted from the aircraft for a first period of time, when the notifier determines that the data signals comprise the emergency alert or when the notifier determines that the aircraft has stopped transmitting any signals. In addition, the method comprises transmitting, by the notifier, first emergency notification messages to other aircraft located within a same airspace as the aircraft, to an air traffic control (ATC) for the airspace of the aircraft, and/or to an airline operations center (AOC) associated with an airlines of the aircraft, after the first period of time has elapsed. Also, the method comprises determining, by the notifier, whether the data signals comprise a lack of voice audio for a second period of time. Further, the method comprises transmitting, by the notifier, second emergency notification messages to the other aircraft located within the same airspace as the aircraft, to the ATC for the airspace of the aircraft, and/or to the AOC associated with the airlines of the aircraft, when the notifier determines that the data signals comprise a lack of voice for the second period of time.

In one or more embodiments, the method further comprises notifying, by the notifier, the ATC to initiate selective calling (SELCAL) with the other aircraft located within the same airspace as the aircraft, when the notifier determines that the data signals comprise a lack of voice for the second period of time. In some embodiments, the method further comprises notifying, by the notifier, a Notice to Airmen (NOTAM) administrator to restrict the airspace of the aircraft, when the notifier determines that the data signals comprise a lack of voice for the second period of time.

In at least one embodiment, the method further comprises fetching, by the notifier, a last known flight position for the aircraft, when the notifier determines that the aircraft has stopped transmitting any signals. In some embodiments, the method further comprises analyzing, by the notifier, a threat level of the airspace of the aircraft, when the notifier determines that the aircraft has stopped transmitting any signals; and transmitting, by the notifier, the second emergency notification messages to the other aircraft located within the same airspace as the aircraft, to the ATC, and/or to the AOC, when the notifier determines that the threat level of the airspace of the aircraft is an amber color (e.g., indicating that the airspace is determined to have a potential safety issue) or a red color (e.g., indicating that the airspace is determined (and/or confirmed) to have a safety issue).

In one or more embodiments, the method further comprises transmitting, by the AOC, third emergency notification messages to other aircraft owned by the same airlines of the aircraft (i.e. an airlines that owns the distressed aircraft) and/or other aircraft owned by different airlines (i.e. different airlines than the airlines that owns the distressed aircraft). In some embodiments, the third emergency notification messages comprise Aircraft Communications Addressing and Reporting System (ACARS) messages.

In at least one embodiment, the method further comprises transmitting, by the notifier, the second emergency notification messages to at least one AOC not associated with the airlines that owns the aircraft (i.e. the distressed aircraft).

In one or more embodiments, black boxes of the aircraft transmit the data signals in real-time, and the black boxes comprise a digital flight data recorder (DFDR) and a cockpit voice recorder (CVR).

In at least one embodiment, the first notification emergency messages and the second notification emergency messages comprise Controller-Pilot Data Link Communications (CPDLC) messages. In some embodiments, the first notification emergency messages comprise a “caution” alert, and the second notification emergency messages comprise a “warning” alert.

In one or more embodiments, a system for emergency notification comprises an aircraft configured to transmit data signals in real-time. The system further comprises a notifier configured to: receive the data signals transmitted from the aircraft; determine whether the data signals comprise an emergency alert; monitor for any subsequent data signals transmitted from the aircraft for a first period of time, when the notifier determines that the data signals comprise the emergency alert or when the notifier determines that the aircraft has stopped transmitting any signals; transmit first emergency notification messages to other aircraft located within a same airspace as the aircraft, to an ATC for the airspace of the aircraft, and/or to an AOC associated with an airlines of the aircraft, after the first period of time has elapsed; determine whether the data signals comprise a lack of voice audio for a second period of time; and transmit second emergency notification messages to the other aircraft located within the same airspace as the aircraft, to the ATC for the airspace of the aircraft, and/or to the AOC associated with the airlines of the aircraft, when the notifier determines that the data signals comprise a lack of voice for the second period of time.

In at least one embodiment, the notifier is further configured to notify the ATC to initiate SELCAL with the other aircraft located within the same airspace as the aircraft, when the notifier determines that the data signals comprise a lack of voice for the second period of time. In some embodiments, the notifier is further configured to notify a NOTAM administrator to restrict the airspace of the aircraft, when the notifier determines that the data signals comprise a lack of voice for the second period of time.

In one or more embodiments, the notifier is further configured to fetch a last known flight position for the aircraft, when the notifier determines that the aircraft has stopped transmitting any signals. In some embodiments, the notifier is further configured to: analyze a threat level of the airspace of the aircraft, when the notifier determines that the aircraft has stopped transmitting any signals; and transmit the second emergency notification messages to the other aircraft located within the same airspace as the aircraft, to the ATC, and/or to the AOC, when the notifier determines that the threat level of the airspace of the aircraft is determined to have a potential safety issue (e.g., denoted by an amber color) or is determined (and/or confirmed) to have a safety issue (e.g., denoted by a red color).

In at least one embodiment, the system further comprises the AOC, which is configured to transmit third emergency notification messages to other aircraft owned by the same airlines of the aircraft and/or other aircraft owned by different airlines of the aircraft. In some embodiments, the third emergency notification messages comprise ACARS messages.

In one or more embodiments, the notifier is further configured to transmit the second emergency notification messages to at least one AOC not associated with the airlines that owns the aircraft.

In at least one embodiment, black boxes of the aircraft are configured to transmit the data signals in real-time, and the black boxes comprise a DFDR and a CVR.

The features, functions, and advantages can be achieved independently in various embodiments of the present disclosure or may be combined in yet other embodiments.

### DRAWINGS

These and other features, aspects, and advantages of the present disclosure will become better understood with regard to the following description, appended claims, and accompanying drawings where:

FIG. 1 is conceptual diagram of the disclosed cloud-based aircraft emergency notifier (CAEN) system, in accordance with at least one embodiment of the present disclosure.

FIGS. 2A and 2B are together a detailed diagram of the disclosed CAEN system, in accordance with at least one embodiment of the present disclosure.

FIGS. 3A and 3B are together a functional block diagram of the disclosed CAEN system, in accordance with at least one embodiment of the present disclosure.

FIGS. 4A, 4B, and 4C are together a flow chart showing the disclosed method for operation of the disclosed CAEN system, in accordance with at least one embodiment of the present disclosure.

### DESCRIPTION

The methods and apparatuses disclosed herein provide operative systems for a Cloud-based Aircraft Emergency Notifier (CAEN). In one or more embodiments, the system of the present disclosure provides a software cloud solution to register and track aircraft emergency incidents as well as to notify other air traffic sharing the airspace, or in close proximity, in near real time.

The system of the present disclosure employs a shared cloud infrastructure across the airlines (and aircraft) that generates automatic push notifications (e.g., comprising detailed emergency information) transmitted to the nearby aircraft. Aircraft black boxes (e.g., digital flight data recorders (DFDRs) and a cockpit voice recorders (CVRs)) with streaming technologies, which are already currently employed in aircraft, are utilized by the disclosed system for the transmission of the emergency information from the aircraft to the cloud infrastructure.

In the present disclosure, disclosed is a CAEN system, which is a ground-based solution, that tracks air traffic by receiving flight data streamed from black boxes of the aircraft. In the case of an emergency alert signal received from an aircraft (e.g., a Mayday or “7700” code in the transponder), the CAEN system will start monitoring the aircraft under distress upon receipt of the signal. And, after a period of time has elapsed, the CAEN system will push notification messages (e.g., Controller-Pilot Data Link Communications (CPDLC) warning messages) to all nearby air traffic, on a real-time basis. A separate notification will also be sent from the CAEN to the air traffic control (ATC) with details of the distressed aircraft and the nearest air traffic.

In particular, during operation, if a distressed aircraft is detected, the CAEN system is programmed to track and monitor the distressed aircraft's status for a time threshold of “t” seconds (e.g., a first period of time). After the time threshold “t” seconds is exceeded, the CAEN will then transmit push notification messages (e.g., a CPDLC “caution” message) to all nearby air traffic on a real-time basis. This allows for the pilots and flight crew in nearby aircraft to be aware of such an incident, thereby resulting in increased situational awareness, and to be prepared for ATC clearances, or to request appropriate flight route amendments and/or clearances. These disclosed notification mechanisms increase the observe-orient-decide-act envelope for the pilot, thereby increasing the safety level of the entire airspace.

In addition to the CPDLC uplink messages and ATC notifications, the CAEN system is networked with the Aeronautical Fixed Telecommunication Network (AFTN), and push notifications from the CAEN system are received at the Controller Working Position (CWP) Server and the NOTAM Server. A CWP ATC Officer can monitor these alert messages and decide to initiate selective calling (SELCAL) to aircraft in the airspace of the distressed aircraft. Also, a NOTAM administrator can monitor these alert messages and decide to generate a NOTAM based on the alert messages. The NOTAMs generated may result in the creation of restricted airspaces.

The CAEN system is also networked to select airline operation centers (AOCs) based on subscriptions with agencies hosting the CAEN system. An AOC center of a subscribing airline may receive push notifications regarding status of the distressed aircraft from the CAEN, and may decide to transmit the distressed aircraft information to at least some of the aircraft in the airline-owned fleet. An AOC crisis management and aircraft tracking and communications team can monitor and analyze the notifications, and communicate with distressed aircraft of other airlines via the Aircraft Communications Addressing and Reporting System (ACARS).

In the following description, numerous details are set forth in order to provide a more thorough description of the system. It will be apparent, however, to one skilled in the art, that the disclosed system may be practiced without these specific details. In the other instances, well known features have not been described in detail, so as not to unnecessarily obscure the system.

Embodiments of the present disclosure may be described herein in terms of functional and/or logical components and various processing steps. It should be appreciated that such components may be realized by any number of hardware, software, and/or firmware components configured to perform the specified functions. For example, an embodiment of the present disclosure may employ various integrated circuit components (e.g., memory elements, digital signal processing elements, logic elements, look-up tables, or the like), which may carry out a variety of functions under the control of one or more processors, microprocessors, or other control devices. In addition, those skilled in the art will appreciate that embodiments of the present disclosure may be practiced in conjunction with other components, and that the systems described herein are merely example embodiments of the present disclosure.

For the sake of brevity, conventional techniques and components related to aircraft emergency notification systems, and other functional aspects of the overall system may not be described in detail herein. Furthermore, the connecting lines shown in the various figures contained herein are intended to represent example functional relationships and/or physical couplings between the various elements. It should be noted that many alternative or additional functional relationships or physical connections may be present in one or more embodiments of the present disclosure.

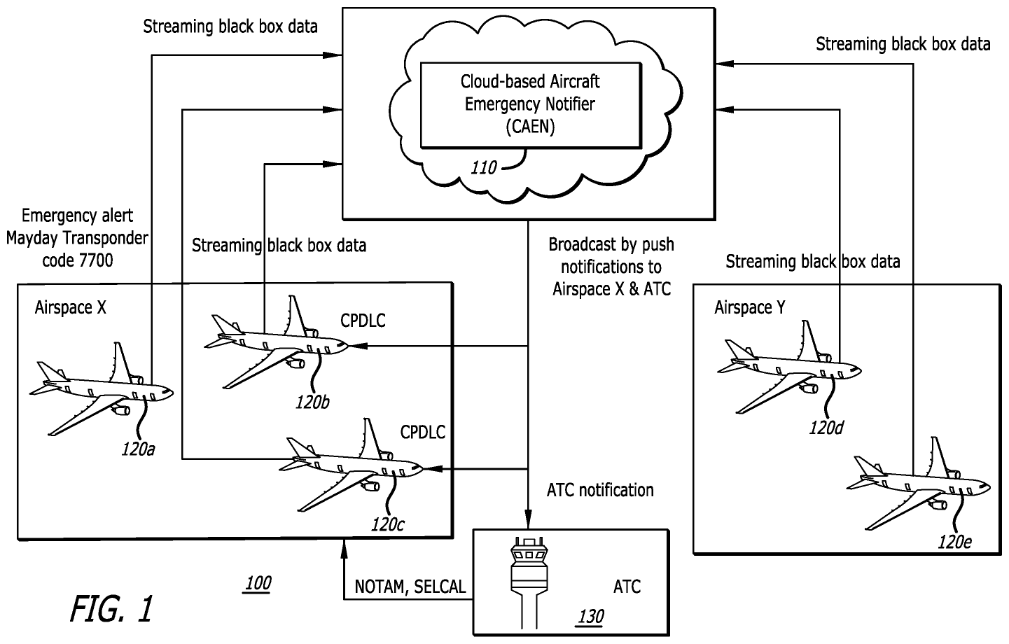

FIG. 1 is conceptual diagram of the disclosed cloud-based aircraft emergency notifier (CAEN) system 100, in accordance with at least one embodiment of the present disclosure. In this figure, the CAEN system 100 is shown to comprise a cloud-based CAEN 110; aircraft 120a, 120b, 120c in airspace X (e.g., a first airspace); aircraft 120c, 120d in airspace Y (e.g., a second airspace); and a ground ATC 130.

During operation of the CAEN system 100, the aircraft 120a, 120b, 120c, 120d, 120e in airspaces X and Y stream black box data (e.g., stream data signals, which contain flight and/or audio data), which may contain emergency information, such as an emergency alert (e.g., a Mayday transponder code “7700”). The CAEN 110 receives and analyzes the black box data from the aircraft 120a, 120b, 120c in airspace X. If the CAEN 110 determines that the black box data received from one of the aircraft (e.g., aircraft 120a in airspace X) contains an emergency alert, the CAEN 110 will attempt to monitor subsequent black box data streamed from the distressed aircraft (e.g., aircraft 120a in airspace X). In the absence of any data streamed from the distressed aircraft or after expiry of a configurable threshold monitoring time, the CAEN 110 will send push notification messages (e.g., first emergency notification messages), such as CPDLC messages, to nearby aircraft within the same airspace as the distressed aircraft (e.g., send messages to aircraft 120b, 120c in airspace X) as well as to the ground ATC 130, which is associated with airspace X.

It should be noted that, in one or more embodiments, the airspaces (e.g., airspaces X and Y) may lie within one designated airspace that is under the surveillance of the ATC 130 or, alternatively the airspaces (e.g., airspace X and Y) may be separate airspaces that are under the surveillance of different ATCs. In addition, it should be noted that, in one or more embodiments, the CAEN 110 may monitor more or less than two airspaces than as shown in FIG. 1.

In one or more embodiments, there may be multiple instances of CAENs 110 deployed in a cloud infrastructure across multiple data centers in different geographies covering designated airspaces or flight information regions. Each of these CAENs 110 is capable of handling a specific number of airspaces, thereby assisting in providing load balancing of the black box data received from the air traffic.

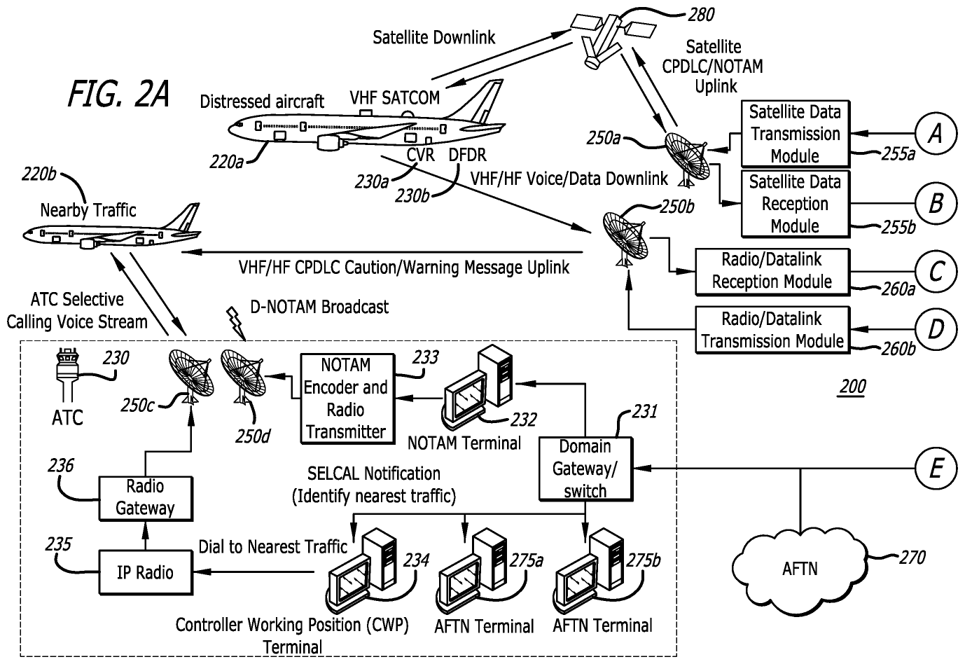

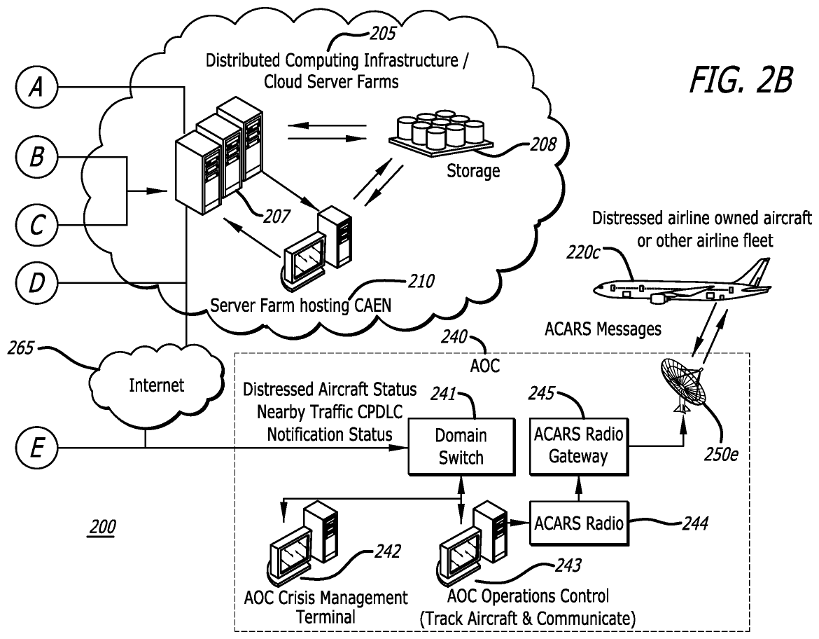

FIGS. 2A and 2B are together a detailed diagram of the disclosed CAEN system 200, in accordance with at least one embodiment of the present disclosure. In this figure, the CAEN system 200 is shown to comprise a plurality of aircraft 220a, 220b, 220c, a CAEN 210, an ATC 230, and an airlines operation center (AOC) 240. Aircraft 220a and 220b are flying nearby each other within a same airspace (e.g., airspace A). Aircraft 220a is a distressed aircraft, and aircraft 220b is a nearby aircraft to the distressed aircraft 220a. Aircraft 220c is an aircraft that is associated with the same airlines as the distressed aircraft 220a, and aircraft 220c may be within the same airspace (e.g., airspace A) of the distressed aircraft 220a or may be within a different airspace (e.g., airspace B) than the distressed aircraft 220a.

A distributed computing infrastructure/cloud server farm 205 (e.g., a commercially available cloud computing service, such as Amazon Web Services (AWS)) comprises a plurality of servers 207 and data storage 208 (e.g., a plurality of databases). At least one of the servers 207 (e.g., a notification server(s)) hosts the CAEN 210 (i.e. a notifier or notification algorithm(s)). It should be noted that, in one or more embodiments, the CAEN 210 may be distributed across servers of more than one distributed computing infrastructure/cloud server farm 205 than as shown in FIGS. 2A and 2B.

The CAEN 210, the ATC 230, and the AOC 204 are networked together with the internet 265 as well as the AFTN 270. The ATC 230 comprises a domain/gateway switch 231, a NOTAM terminal 232, a NOTAM encoder and radio transmitter 233, AFTN terminals 275a, 275b, a controller working position (CWP) terminal 234, an internet protocol (IP) radio 235, a radio gateway 236, and ground antennas 250c, 250d. The AOC 240 comprises a domain switch 241, an AOC crisis management terminal 242, an AOC operations control 243, an ACARS radio 244, an ACARS radio gateway 245, and a ground antenna 250e.

In one or more embodiments, during operation of the CAEN system 200, the aircraft 220a transmits black box data (e.g., data signals comprising flight data) from its DFDR 230b to a ground antenna 250a via a satellite 280 using a satellite communication (SATCOM) link. A satellite data reception module 255b then receives the black box data, which is then transmitted to the distributed computing infrastructure/cloud server farm 205 hosting the CAEN 210 (e.g., a notifier). The CAEN 210 analyzes the black box data for an emergency alert.

If the CAEN 210 determines that the black box data from the aircraft 220a contains an emergency alert, the CAEN 210 designates the aircraft 220a as a distressed aircraft. The CAEN 210 then monitors subsequent black box data received from the distressed aircraft 220a for a designated period of time “t₁” (e.g., a first period of time). After the period of time “t₁” has elapsed, the CAEN 210 automatically transmits emergency notification messages to any aircraft that is nearby (e.g., within the same airspace of) the distressed aircraft 220a. As such, the CAEN 210 will transmit emergency notification messages to aircraft 220b, which is nearby the distressed aircraft 220a, via a radio/downlink transmission module 260b and a ground antenna 250b using a very-high frequency (VHF)/high frequency (HF) CPDLC caution/warning message uplink. Also, after the period of time “t₁” has elapsed, the CAEN 210 will also automatically transmit emergency notification messages to an ATC 230, which is associated with the airspace of the distressed aircraft 220b, via the internet 265. In addition, after the period of time “t₁” has elapsed, the CAEN 210 will automatically transmit emergency notification messages to an AOC 240, which is associated with the same airlines of the distressed aircraft 220a, via the internet 265. In some embodiments, after the period of time “t₁” has elapsed, the CAEN 210 will automatically transmit emergency notification messages to an AOC(s) (not shown), which is not associated with the same airlines of the distressed aircraft 220a but subscribes to the CAEN system 200, via the internet 265.

Also, during operation of the CAEN system 200, the aircraft 220a transmits black box data (e.g., data signals comprising voice audio data from the cockpit) from its CVR 230a to the ground antenna 250b using a VHF/HF voice/data downlink or via a satellite downlink. A radio/datalink reception module 260a then receives the black box data, which is then transmitted to the distributed computing infrastructure/cloud server farm 205 hosting the CAEN 210. The CAEN 210 analyzes the black box data for a lack of voice audio for a period of time “t₂” (e.g., a second period of time).

If the CAEN 210 determines that the black box data does not contain any voice audio for the period of time “t₂”, the CAEN 210 designates the aircraft 220a as a distressed aircraft, and the CAEN 210 automatically transmits emergency notification messages to any aircraft that is nearby (e.g., within the same airspace of) the distressed aircraft 220a, such as aircraft 220b, via the radio/downlink transmission module 260b and the ground antenna 250b using a VHF/high frequency HF CPDLC caution/warning message uplink or via a satellite CPDLC uplink. Also, if the CAEN 210 determines that the black box data does not contain any voice audio for the period of time “t₂”, the CAEN 210 will automatically transmit emergency notification messages to the ATC 230, which is associated with the airspace of the distressed aircraft 220b, via the internet 265. In addition, if the CAEN 210 determines that the black box data does not contain any voice audio for the period of time “t₂”, the CAEN 210 will automatically transmit emergency notification messages to the AOC 240, which is associated with the same airlines of the distressed aircraft 220a, via the internet 265. In some embodiments, if the CAEN 210 determines that the black box data does not contain any voice audio for the period of time “t₂”, the CAEN 210 will automatically transmit emergency notification messages to an AOC(s) (not shown), which is not associated with the same airlines of the distressed aircraft 220a but subscribes to the CAEN system 200, via the internet 265.

In addition, if the CAEN 210 determines that the black box data does not contain any voice audio for the period of time 12″, the CAEN 210 will notify a controller at the CWP terminal 234 of the ATC 230 to initiate selective calling (SELCAL) with the nearby aircraft traffic (e.g., within the same airspace of) to the distressed aircraft 220a, such as aircraft 220b. A SELCAL voice stream will be transmitted from the ATC 230 to the nearby aircraft traffic (e.g., aircraft 220b) via the IP radio 235, the radio gateway 236, and the ground antenna 250c.

Also, if the CAEN 210 determines that the black box data does not contain any voice audio for the period of time 12″, the CAEN 210 will also notify a NOTAM administrator at the NOTAM terminal 232 of the ATC 230 to evaluate and generate a NOTAM to restrict the airspace (e.g., airspace A) of the distressed aircraft 220a. The NOTAM will be broadcasted (e.g., a D-NOTAM broadcast) from the ATC 230 to the aircraft (e.g., aircraft 220b) within the airspace (e.g., airspace A) via the NOTAM encoder and radio transmitter 233 and the ground antenna 250d.

In addition, an AOC crisis management and aircraft tracking and communications team at a AOC crisis management terminal(s) 242 of the AOC 240 can monitor and analyze the emergency notification messages, and communicate with (e.g., send the emergency notification messages to) aircraft (e.g., aircraft 220c) of the same airlines of the distressed aircraft 220a and/or a different airlines of the distressed aircraft 220a using ACARS messages transmitted via the ACARS radio 244, the ACARS radio gateway 245, and the ground antenna 250e.

Also, in one or more embodiments, the CAEN 210 may also attempt to communicate with the distressed aircraft 220a by transmitting communication signals to the aircraft 220a via the satellite data transmission module 255a, the ground antenna 250a, and the satellite 240 using a satellite CPDLC/NOTAM uplink.

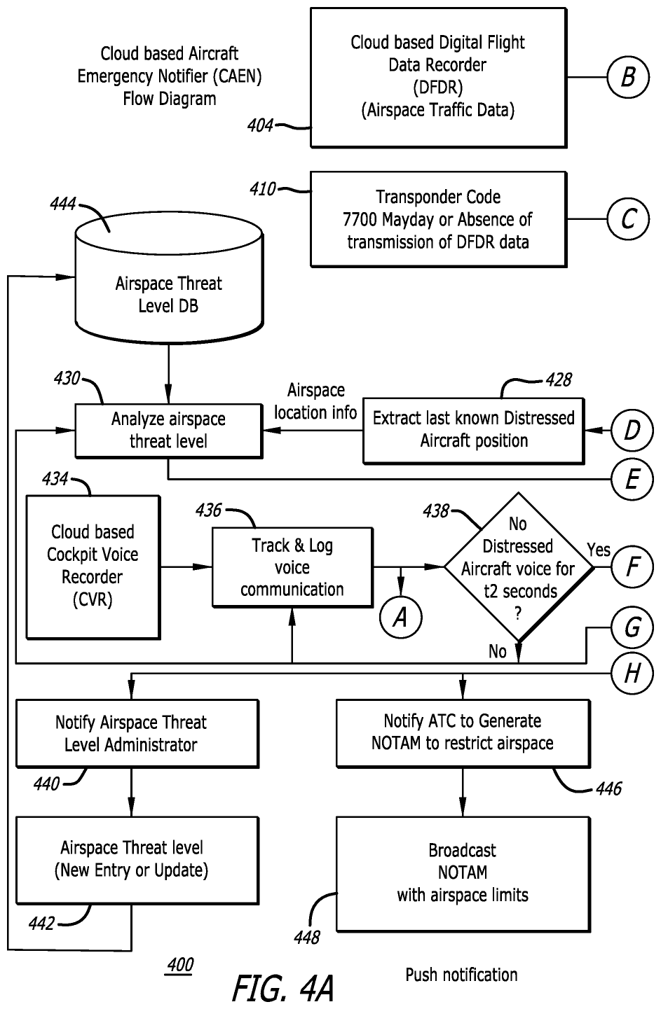

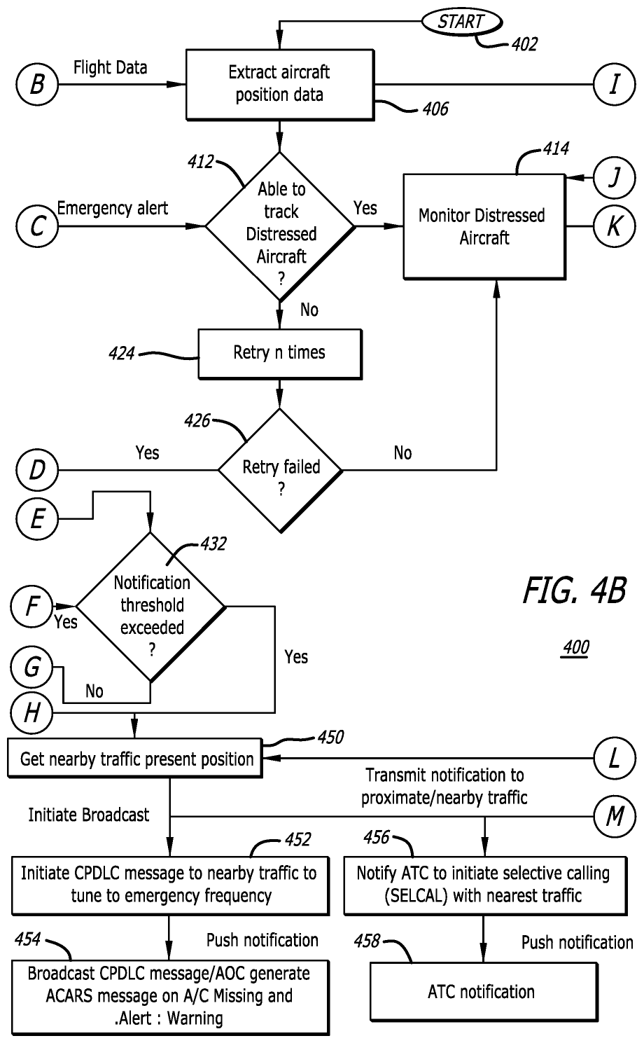

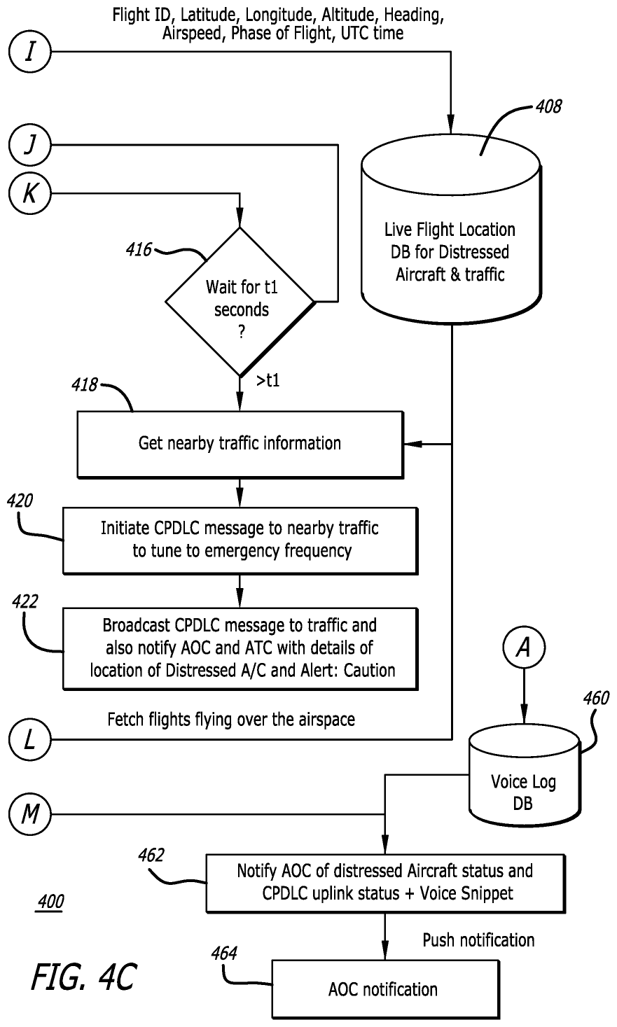

It should be noted that additional specific details regarding the operation of the CAEN system 200 are discussed in the description of FIGS. 4A, 4B, and 4C, which together depict the method 400 of operation of the CAEN system 200.

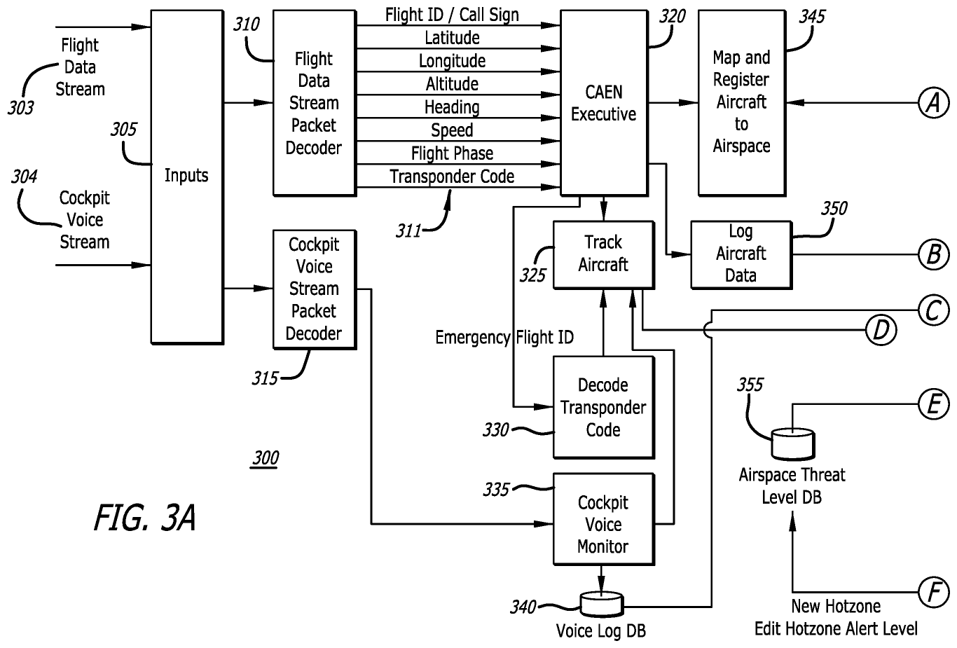

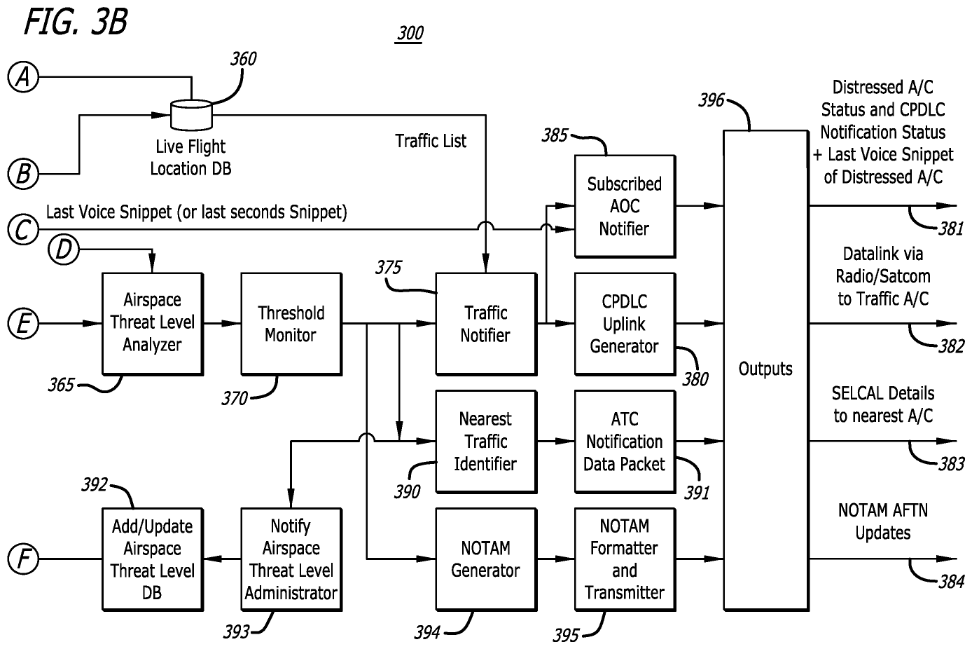

FIGS. 3A and 3B are together a functional block diagram of the disclosed CAEN system 300, in accordance with at least one embodiment of the present disclosure. In this figure, a flight data stream 303 (e.g., from a DFDR(s) of at least one aircraft during flight) and a cockpit voice stream 304 (e.g., from a CVR(s) of at least one aircraft during the flight) are received as inputs 305. A flight data stream pack decoder 310 decodes the flight data stream 303 to generate the flight data 311 relating to at least one aircraft. The flight data 311 includes, but is not limited to, flight identification (ID)/call sign, latitude, longitude, altitude, heading, speed, flight phase, transponder code, and coordinated universal time (UTC).

The flight data 311 is inputted into a CAEN executive 320. The CAEN executive 320 is a central manager, which periodically captures the flight data 311, and makes the flight data 311 available to other components/modules of the CAEN. A log aircraft data module 350 receives the flight data 311 from the CAEN executive 320, and logs the flight data 311 of at least one aircraft. The flight data 311 is also stored within a live flight location database (DB) 360.

A map and register aircraft to airspace module 345 receives the flight data 311 from the CAEN executive 320, and retrieves data from the live flight location database 360. The map and register aircraft to airspace module 345 uses the flight data 311 along with data from the live flight location database 360 to map and register at least one aircraft to an airspace(s). A track aircraft module 325 also receives the flight data 311 from the CAEN executive 320, and uses the flight data 311 to track freshness and location of at least one aircraft.

A cockpit voice stream pack decoder 315 decodes the cockpit voice stream 304 to generate the audio captured within the cockpit. The cockpit voice monitor module 335 receives the audio from the cockpit voice stream pack decoder 315, extracts voice data from the audio, and stores the voice data within a voice log database 340. The cockpit voice monitor module 335 also monitors the audio for the absence of any voice data. If the cockpit voice monitor module 335 determines that there is an absence of voice data in the audio received from an aircraft, the cockpit voice monitor module 335 notifies the track aircraft module 325 of the lack of voice data from that aircraft.

The decode transponder code module 330 receives the flight data 311 from the CAEN executive, and monitors the flight data (e.g., the transponder code) 311 to determine whether any aircraft have tuned to an emergency code (e.g., a Mayday “7700” transponder code), which indicates an emergency alert. If the decode transponder code module 330 determines that an aircraft has tuned to an emergency code, the decode transponder code module 330 will determine that the aircraft is a distressed aircraft and will give the flight ID/call sign (e.g., emergency flight ID) of the distressed aircraft to the track aircraft module 325.

An airspace threat level database 355 keeps a record of the threat levels across different airspaces based on various geopolitical situations and/or environmental conditions (e.g., volcanic ash, forest fires, and thunderstorms), which may create a “hot zone” for an airspace(s). The airspace threat level database 355 is maintained by an airspace threat level administrator, who can add and/or update the threat levels of airspaces 392 based on “hot zones”, which may be created by geopolitical and/or environmental events. “Hot zones” may be graded with different threat level colors, such as “green” to indicate that there is no threat, “amber” to indicate caution, and “red” to indicate to avoid.

If the track aircraft module 325 determines that there is a loss of aircraft data (e.g., lack of voice data) and/or an emergency alert from the aircraft, the track aircraft module 325 will notify the airspace threat level analyzer module 365 of the distressed aircraft. The threat level analyzer module 365 will use a threshold monitor 370 to determine whether push notification messages (e.g., emergency notification messages) should be transmitted to aircraft traffic nearby (e.g., within the same airspace) the distressed aircraft; an ATC(s), which may (or may not) be associated with the airspace(s) of the distressed aircraft; and an AOC(s), which may (or may not) be associated with the same airline of the distressed aircraft.

The threat level analyzer module 365 will determine that the threat threshold has been exceeded (e.g., breached) when any of the following situations has occurred: (1) an emergency code is received from an aircraft, and a time threshold (e.g., a first period of time) has been exceeded when the distressed aircraft is being tracked, (2) there is a loss of signal(s) from an aircraft, (3) there is a loss of voice from an aircraft, and/or (4) a threat level of the airspace is high, such as an airspace with a threat level color of “amber” or “red”.

When the threat level analyzer module 365 determines that the threat threshold has been exceeded, the following events will take place: (1) the airspace threat level administrator 393 is notified about the event so that the airspace threat level database 355 can be updated 392, (2) a traffic notifier module 375 obtains a listing (e.g., a traffic list) of the aircraft flying nearby (e.g., within the same airspace as) the distressed aircraft from the live flight location database 360, (3) a CPDLC uplink generator 380 transmits (e.g., outputs 396) emergency messages to the nearby aircraft (A/C) using a datalink via radio/SATCOM 382, (4) an ATC notification data packet 391 is generated using the identification of the nearby aircraft 390, (5) an ATC(s), which may or may not be associated with the distressed aircraft, and/or the air navigation service provider (ANSP) are notified with the ATC notification data packet 391, which comprises the distressed aircraft status, CPDLC notification status, and a last voice snippet of the distressed aircraft 381, (6) a NOTAM generator 394 creates a NOTAM 384, which is formatted and transmitted by a NOTAM formatter and transmitter module 395, to be sent through the AFTN to restrict the airspace of the distressed aircraft, (7) a subscribed AOC notifier 385 notifies a subscribed AOC(s) of the distressed aircraft and CPDLC uplink notification status as well as the last voice snippet from the distressed aircraft 381, and (8) an ATC(s), which may or may not be associated with the distressed aircraft, is notified 383 to initiate SELCAL with the aircraft nearby (e.g., within the same airspace as) the distressed aircraft.

FIGS. 4A, 4B, and 4C are together a flow chart showing the disclosed method 400 for operation of the disclosed CAEN system 100, 200, 300 of FIGS. 1, 2A, 2B, 3A, and 3B, in accordance with at least one embodiment of the present disclosure. At the start 402 of the method 400, the CAEN receives a flight data stream from the DFDR of an aircraft 404. The CAEN decodes the flight data stream to extract the aircraft position data (e.g., flight ID, latitude, longitude, altitude, heading, airspeed, phase of flight, and UTC time) 406. The aircraft position data is then stored in a live flight location database for distressed aircraft and traffic 408.

In addition, the CAEN receives an emergency alert (e.g., which is indicated by receiving a Mayday transponder code of “7700” or by an absence of transmission of data from the DFDR) from the aircraft 410. It should be noted that the CAEN will consider it to be an emergency state (e.g., which is equivalent to an emergency alert) if the aircraft DFDR stops transmitting any data, even if the aircraft has not specifically transmitted an emergency alert (e.g., a Mayday code).

After receiving an emergency alert, the CAEN designates the aircraft as a distressed aircraft. The CAEN then determines if it is able to track the distressed aircraft 412. If the distressed aircraft is still transmitting DFDR data, the CAEN is able to track the aircraft, and the CAEN will then operate in a monitoring state. The CAEN monitors the distressed aircraft for any subsequent data streams from the DFDR for the persistence of the emergency state 414 for a period of time “t₁” (e.g., a first period of time) 416.

After the period of time “t₁” has elapsed, if the CAEN continues to receive any flight data from the DFDR of the distressed aircraft, the CAEN determines the aircraft nearby (e.g., within the same airspace as) the distressed aircraft 418 by using data from the live flight location database for distressed aircraft and traffic 408. The CAEN then sends a CPDLC uplink message to the aircraft nearby (e.g., within the same airspace as) the distressed aircraft to tune to an emergency frequency 420. The CAEN then broadcasts CPDLC emergency notification messages (e.g., first emergency notification messages) to the nearby aircraft, and also sends the emergency notification messages to an AOC(s) (which is associated with the airline of the distressed aircraft or subscribes to the CAEN system) and the ATC (which is associated with the airspace of the distressed aircraft) 422. The emergency notification messages contain the location of the distressed aircraft and contain a “caution” alert 422. After the emergency notification messages are sent by the CAEN, the CAEN continues to monitor the distressed aircraft for any subsequent data streams from the DFDR for the persistence of the emergency state 414.

However, if the CAEN does not continue to receive any flight data from the DFDR of the distressed aircraft, the CAEN will retry to track the distressed aircraft “n” number of times 424. If the CAEN is able to track the distressed aircraft (i.e. the retry has not failed 426), the CAEN monitors the distressed aircraft for any subsequent data streams from the DFDR for the persistence of the emergency state 414.

However, if the CAEN is not able to track the distressed aircraft after “n” number of times (i.e. the retry failed 426), the CAEN fetches (e.g., extracts) the last known position of the distressed aircraft 428, and queries the aircraft threat level database 444 to obtain the latest threat level (e.g., a “green” (i.e. indicating that the airspace is determined to be safe), “amber” (i.e. indicating that the airspace is determined to have a potential safety issue), or “red” (i.e. indicating that the airspace is determined to have a safety issue) color) of the airspace of the distressed aircraft. If the threat level is an “amber” or “red” color, a notification threshold has been exceeded 432, and the CAEN switches to a notification state. However, if the threat level is a “green” color, the notification threshold has not been exceeded 432, and the CAEN continues to analyze the threat level of the airspace of the distressed aircraft 430.

The CAEN also receives a voice stream from the CVR of the aircraft 434. The CAEN monitors the CVR voice stream for voice data, and tracks the voice communication in the voice data and logs the voice data from the voice stream 436 in a voice log database 460. The CAEN continues to monitor the voice stream for voice data from the distressed aircraft. If the CAEN does not receive voice data from the distressed aircraft within a period of time “t₂” (e.g., a second period of time), the notification threshold has been exceeded 432, and the CAEN switches to a notification state. However, if the CAEN does receive voice data from the distressed aircraft within the period of time “t₂” (e.g., a second period of time) 438, the CAEN continues to track and log the voice data from the voice stream 436.

When the CAEN is in a notification state, the CAEN determines the aircraft nearby (e.g., within the same airspace as) the last known position of the distressed aircraft 450 by fetching flights (e.g., flight data for aircraft) flying over the airspace from the live flight location database for distressed aircraft and traffic 408. The CAEN then sends a CPDLC uplink message to the aircraft nearby (e.g., within the same airspace as) the distressed aircraft to tune to an emergency frequency 452. The CAEN then broadcasts CPDLC emergency notification messages (e.g., second emergency notification messages) to the nearby aircraft, and also sends the emergency notification messages to an AOC(s) (which is associated with the airline of the distressed aircraft or subscribes to the CAEN system) and the ATC (which is associated with the airspace of the distressed aircraft) 454. The AOC(s) also sends the emergency notification messages (e.g., second emergency notification messages) to aircraft of the same airlines of the distressed aircraft and/or a different airline of the distressed aircraft using ACARS messages 454. The emergency notification messages contain the location of the distressed aircraft and contain a “warning” alert 454.

Also, when the CAEN is in a notification state, the CAEN notifies the ATC to initiate SELCAL with the nearby aircraft to the distressed aircraft 456, and then the ATC pushes an emergency notification 458. Additionally, when the CAEN is in a notification state, the CAEN notifies the NOTAM administrator to generate a NOTAM to restrict the airspace of the distressed aircraft 446. Then, a NOTAM with the airspace limits is broadcasted 448.

In addition, when the CAEN is in a notification state, the CAEN notifies the airspace threat level database administrator 440 to review and/or update the threat level of the airspace or add a new “hot zone” 442. The updated threat level(s) and/or additional “hot zone(s)” are stored in the threat level database 444.

Also, when the CAEN is in a notification state, the CAEN notifies the AOC associated with the airline of the distressed aircraft of the last known position of the distressed aircraft and provides a voice snippet of the last conversation of a length “t₃” seconds before the loss of voice 462. The CAEN also notifies all other subscribed AOCs with the status of the CPDLC messages that are broadcast and the details of the distressed aircraft 462, and then the AOC pushes an emergency notification 464.

Although particular embodiments have been shown and described, it should be understood that the above discussion is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims.

Where methods described above indicate certain events occurring in certain order, those of ordinary skill in the art having the benefit of this disclosure would recognize that the ordering may be modified and that such modifications are in accordance with the variations of the present disclosure. Additionally, parts of methods may be performed concurrently in a parallel process when possible, as well as performed sequentially. In addition, more steps or less steps of the methods may be performed.

Accordingly, embodiments are intended to exemplify alternatives, modifications, and equivalents that may fall within the scope of the claims.

Although certain illustrative embodiments and methods have been disclosed herein, it can be apparent from the foregoing disclosure to those skilled in the art that variations and modifications of such embodiments and methods can be made without departing from the true spirit and scope of this disclosure. Many other examples exist, each differing from others in matters of detail only. Accordingly, it is intended that this disclosure be limited only to the extent required by the appended claims and the rules and principles of applicable law.

We claim:

1. A method for emergency notification, the method comprising:
receiving, by a notifier, data signals transmitted from an aircraft;
determining, by the notifier, whether the data signals comprise an emergency alert;
monitoring, by the notifier, for any subsequent data signals transmitted from the aircraft for a first period of time, when the notifier determines that the data signals comprise the emergency alert or when the notifier determines that the aircraft has stopped transmitting any signals;
transmitting, by the notifier, first emergency notification messages to at least one of other aircraft located within a same airspace as the aircraft, to an air traffic control (ATC) for the airspace of the aircraft, or to an airline operations center (AOC) associated with an airlines of the aircraft, after the first period of time has elapsed;
determining, by the notifier, whether the data signals comprise a lack of voice audio for a second period of time; and
transmitting, by the notifier, second emergency notification messages to at least one other aircraft located within the same airspace as the aircraft, to the ATC for the airspace of the aircraft, or to the AOC associated with the airlines of the aircraft, when the notifier determines that the data signals comprise the lack of voice for the second period of time.

2. The method of claim 1, wherein the method further comprises notifying, by the notifier, the ATC to initiate selective calling (SELCAL) with at least one of the other aircraft located within the same airspace as the aircraft, when the notifier determines that the data signals comprise the lack of voice for the second period of time.

3. The method of claim 1, wherein the method further comprises notifying, by the notifier, a Notice to Airmen (NOTAM) administrator to restrict the airspace of the aircraft, when the notifier determines that the data signals comprise the lack of voice for the second period of time.

4. The method of claim 1, wherein the method further comprises fetching, by the notifier, a last known flight position for the aircraft, when the notifier determines that the aircraft has stopped transmitting any signals.

5. The method of claim 1, wherein the method further comprises:
analyzing, by the notifier, a threat level of the airspace of the aircraft, when the notifier determines that the aircraft has stopped transmitting any signals; and
transmitting, by the notifier, the second emergency notification messages to at least one of the other aircraft located within the same airspace as the aircraft, to the ATC, or to the AOC, when the notifier determines that the threat level of the airspace of the aircraft is determined to have a potential safety issue or is determined to have a safety issue.

6. The method of claim 1, wherein the method further comprises transmitting, by the AOC, third emergency notification messages to at least one of other aircraft owned by a same airlines of the aircraft or other aircraft owned by different airlines of the aircraft.

7. The method of claim 6, wherein the third emergency notification messages comprise Aircraft Communications Addressing and Reporting System (ACARS) messages.

8. The method of claim 1, wherein the method further comprises transmitting, by the notifier, the second emergency notification messages to at least one AOC not associated with the airlines that owns the aircraft.

9. The method of claim 1, wherein black boxes of the aircraft transmit the data signals in real-time, and
wherein the black boxes comprise a digital flight data recorder (DFDR) and a cockpit voice recorder (CVR).

10. The method of claim 1, wherein the first notification emergency messages and the second notification emergency messages comprise Controller-Pilot Data Link Communications (CPDLC) messages.

11. The method of claim 1, wherein the first notification emergency messages comprise a “caution” alert, and wherein the second notification emergency messages comprise a “warning” alert.

12. A system for emergency notification, the system comprising:
an aircraft configured to transmit data signals in real-time; and
a notifier configured to:
receive the data signals transmitted from the aircraft,
determine whether the data signals comprise an emergency alert,
monitor for any subsequent data signals transmitted from the aircraft for a first period of time, when the notifier determines that the data signals comprise the emergency alert or when the notifier determines that the aircraft has stopped transmitting any signals,
transmit first emergency notification messages to at least one of other aircraft located within a same airspace as the aircraft, to an air traffic control (ATC) for the airspace of the aircraft, or to an airline operations center (AOC) associated with an airlines of the aircraft, after the first period of time has elapsed,
determine whether the data signals comprise a lack of voice audio for a second period of time, and
transmit second emergency notification messages to at least one of the other aircraft located within the same airspace as the aircraft, to the ATC for the airspace of the aircraft, or to the AOC associated with the airlines of the aircraft, when the notifier determines that the data signals comprise the lack of voice for the second period of time.

13. The system of claim 12, wherein the notifier is further configured to notify the ATC to initiate selective calling (SELCAL) with at least one of the other aircraft located within the same airspace as the aircraft, when the notifier determines that the data signals comprise the lack of voice for the second period of time.

14. The system of claim 12, wherein the notifier is further configured to notify a Notice to Airmen (NOTAM) administrator to restrict the airspace of the aircraft, when the notifier determines that the data signals comprise the lack of voice for the second period of time.

15. The system of claim 12, wherein the notifier is further configured to fetch a last known flight position for the aircraft, when the notifier determines that the aircraft has stopped transmitting any signals.

16. The system of claim 12, wherein the notifier is further configured to:
analyze a threat level of the airspace of the aircraft, when the notifier determines that the aircraft has stopped transmitting any signals; and
transmit the second emergency notification messages to at least one of the other aircraft located within the same airspace as the aircraft, to the ATC, or to the AOC, when the notifier determines that the threat level of the airspace of the aircraft is determined to have a potential safety issue or is determined to have a safety issue.

17. The system of claim 12, wherein the system further comprises the AOC, which is configured to transmit third emergency notification messages to at least one of other aircraft owned by a same airlines of the aircraft or other aircraft owned by different airlines of the aircraft.

18. The system of claim 17, wherein the third emergency notification messages comprise Aircraft Communications Addressing and Reporting System (ACARS) messages.

19. The system of claim 12, wherein the notifier is further configured to transmit the second emergency notification messages to at least one AOC not associated with the airlines that owns the aircraft.

20. The system of claim 12, wherein black boxes of the aircraft are configured to transmit the data signals in real-time, and wherein the black boxes comprise a digital flight data recorder (DFDR) and a cockpit voice recorder (CVR).
